(19) United States
(12) Patent Application Publication
(10) Pub. No.: US 2026/0088845 A1
(43) Pub. Date: Mar. 26, 2026

(54) Adaptive Filtering for Sub-System Coexistence

(71) Applicant: Apple Inc., Cupertino, CA (US)

(72) Inventors: Vijaykrishnan Ramakrishnan, San Jose, CA (US); Puneeth Prahalad, Cupertino, CA (US); Siddharth Ravichandran, San Jose, CA (US)

(21) Appl. No.: 18/898,052

(22) Filed: Sep. 26, 2024

(51) Int. Cl. H04B 1/10

(52) U.S. Cl. CPC H04B 1/1027; H04B 1/1018; H04B 2001/1045; H04B 2001/1072

(57) ABSTRACT

An electronic device may include aggressor circuitry that produces noise at a victim frequency, which can adversely affect the operation of victim circuitry. Tunable filter circuitry may be coupled to the aggressor circuitry and/or the victim circuitry. Control circuitry may control the filter state of the tunable filter circuitry based on victim circuitry state and/or aggressor circuitry state to remove the noise at the victim frequency.

### FIELD

This disclosure relates generally to electronic devices such as electronic devices with multiple coexisting sub-systems.

### BACKGROUND

Electronic devices are often provided with wireless communications capabilities. An electronic device with wireless communications capabilities has wireless communications circuitry. Some wireless communications circuitry can be susceptible to interference (noise) at its operating frequency caused by operation of other wireless communications circuitry and/or operation of other sub-systems in the same electronic device. Especially in a compact electronic device, these types of interference issues may be challenging to address given the number and different types of sub-systems and their close proximity to each other.

### SUMMARY

An electronic device may include a first sub-system containing first circuitry that produces noise at a victim frequency, which can adversely affect the operation of second circuitry in a second sub-system. The first sub-system and the first circuitry can sometimes be referred to as an aggressor sub-system and aggressor circuitry, whereas the second sub-system and the second circuitry can sometimes be referred to as a victim sub-system and victim circuitry. The electronic device may include multiple aggressor sub-systems, each containing corresponding aggressor circuitry, and multiple victim sub-systems, each containing corresponding victim circuitry. First tunable filter circuitry may be coupled to any number of instances of aggressor circuitry and/or second tunable filter circuitry may be coupled to any number of instances of victim circuitry. Control circuitry may control the filter states of the first and second tunable filter circuitry based on victim circuitry state information and/or aggressor circuitry state information to remove one or more noise components at one or more victim frequencies.

An aspect of the disclosure provides wireless communications circuitry. The wireless communications circuitry can include radio-frequency circuitry coupled to a signal path configured to convey a signal containing a victim frequency noise component that impacts victim circuitry operation, can include tunable filter circuitry coupled to the signal path and having a plurality of filter states, and can include control circuitry configured to receive victim circuitry state information and place the tunable filter circuitry in a given filter state of the plurality of filter states to remove the victim frequency noise component from the signal based on the received victim circuitry state information.

An aspect of the disclosure provides an electronic device. The electronic device can include an aggressor sub-system having first circuitry that operates with a signal containing a noise component at a victim frequency, can include a victim sub-system having second circuitry that operates at the victim frequency, can include a tunable filter network coupled to the first circuitry and having a plurality of filter states, and can include control circuitry configured to receive an indication of one or more victim sub-systems, including the victim sub-system, being active and place the tunable filter network in a given filter state of the plurality of filter states to remove the noise component from the signal based on the indication of the one or more active victim sub-systems.

An aspect of the disclosure provides circuitry. The circuitry can include storage circuitry and one or more processors coupled to the storage circuitry. The one or more processors can be configured to receive first state information of one or more victim sub-systems and second state information of one or more aggressor sub-systems, the one or more aggressor sub-systems producing a signal having one or more victim frequencies that interferes with operation of the one or more victim sub-systems. The one or more processors can be configured to determine a filter state of tunable filter circuitry coupled to the one or more aggressor sub-systems based on the first and second state information, and provide one or more control signals to the tunable filter circuitry that place the tunable filter circuitry in the determined filter state.

### BRIEF DESCRIPTION OF THE DRAWINGS

FIG. 1 is a diagram of an illustrative electronic device having wireless communications circuitry in accordance with some embodiments.

FIG. 2 is a diagram of illustrative wireless communications circuitry in accordance with some embodiments.

FIG. 3 is a diagram of an illustrative electronic device with a sub-system serving as an aggressor towards a victim sub-system in accordance with some embodiments.

FIG. 4 is a diagram of illustrative radio-frequency aggressor and victim circuitry in accordance with some embodiments.

FIG. 5 is a diagram of illustrative aggressor circuitry coupled to tunable filter circuitry adaptively controlled to remove victim frequency noise in accordance with some embodiments.

FIG. 6 is a diagram of illustrative tunable filter circuitry in accordance with some embodiments.

FIG. 7 is an illustrative lookup table mapping victim circuitry state information to filter state information of tunable filter circuitry in accordance with some embodiments.

FIG. 8 is a diagram of illustrative victim circuitry coupled to tunable filter circuitry adaptively controlled to remove victim frequency noise in accordance with some embodiments.

FIG. 9 is an illustrative graph showing power spectral density of signals based on adaptive filtering in accordance with some embodiments.

### DETAILED DESCRIPTION

An electronic device may include multiple sub-systems. Operation of a first (aggressor) sub-system can sometimes interfere with operation of a second (victim) sub-system. In particular, the victim sub-system may include (victim) circuitry that operates at a victim frequency. The aggressor sub-system may include (aggressor) circuitry that produces noise (e.g., broadband noise) having a victim frequency noise component, which when conveyed to the victim circuitry, interferes with victim circuitry operation at the victim frequency.

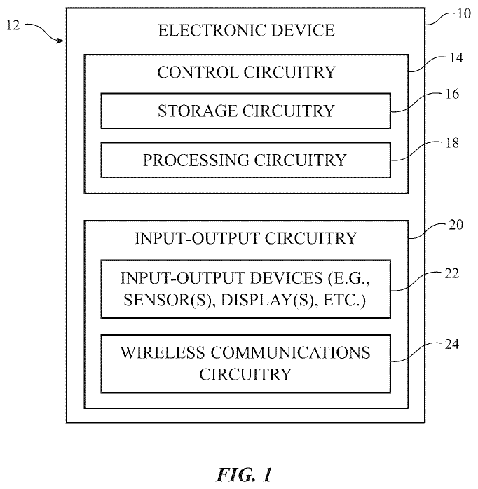

In illustrative configurations sometimes described herein as an example, tunable filter circuitry (sometimes referred to as a tunable filter network) may be coupled to one or more instances of aggressor circuitry. The tunable filter circuitry may include filters that remove the victim frequency noise components at different victim frequencies and switching circuitry between the filters and the instance(s) of aggressor circuitry. Based on the states of the victim circuitry instances (e.g., which victim circuitry instance(s) are active and operating, the signal quality metric of operating signals of the victim circuitry instance(s), etc.) and/or the states of aggressor circuitry instances (e.g., which aggressor circuitry instance(s) are active and operating, the noise profile of the aggressor circuitry instance(s), etc.), control circuitry may place the tunable filter circuitry in an appropriate filter state to reject (filter out) victim frequency noise component(s) in the corresponding operating scenario. By adaptively filtering out (different) victim frequency noise depending on operating scenario, co-existence of multiple sub-systems is promoted, especially in an electronic device having numerous sub-systems (e.g., display sub-system(s), camera sub-system(s), sensor sub-system(s), wireless circuitry sub-system(s), etc.). An illustrative electronic device in which adaptive filtering of victim frequency noise (e.g., in the manner described above) can be employed is shown in FIG. 1.

FIG. 1 is a diagram of an illustrative electronic device such as electronic device 10. Electronic device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18 (e.g., one or more processors 18). Processing circuitry 18 may be used to control the operation of device 10. Processing circuitry 18 may include one or more microprocessors, microcontrollers, digital signal processors, host processors, baseband processor integrated circuits, application processors, application specific integrated circuits, central processing units (CPUs), general purpose processors, or other types of processors. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G New Radio (NR) protocols, etc.), MIMO protocols, antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, electronic pencil (e.g., a stylus), and joysticks, and other input-output devices may be coupled to device 10 using wired or wireless connections (e.g., some of input-output devices 22 may be peripherals that are coupled to a main processing unit or other portion of device 10 via a wired or wireless link).

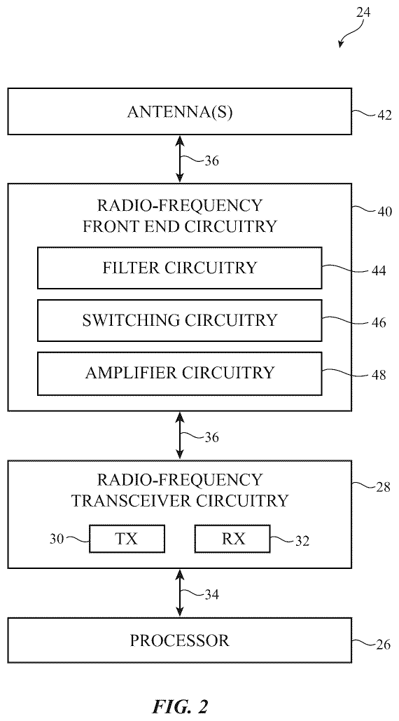

Input-output circuitry 20 may include wireless communications circuitry such as wireless communications circuitry 24 (sometimes referred to herein as wireless circuitry 24) for wirelessly conveying radio-frequency signals. FIG. 2 is a diagram showing illustrative components within wireless circuitry 24. As shown in FIG. 2, wireless circuitry 24 may include one or more processors such as processor 26, radio-frequency (RF) transceiver circuitry such as radio-frequency transceiver circuitry 28, radio-frequency front end circuitry such as radio-frequency front end circuitry 40 (which, when integrated, may sometimes be referred to as front end module 40), and one or more antennas such as antenna(s) 42. Processor 26 may be a baseband processor, application processor, general purpose processor, microprocessor, microcontroller, digital signal processor, host processor, or other type of processor. If desired, processor 26 may be implemented as part of control circuitry 14. Processor 26 may be coupled to transceiver circuitry 28 over path 34. Transceiver circuitry 28 may be coupled to antenna(s) 42 via radio-frequency transmission line path(s) 36. Radio-frequency front end circuitry 40 may be disposed along (e.g., on) radio-frequency transmission line path(s) 36 between transceiver circuitry 28 and antenna(s) 42.

In the example of FIG. 2, wireless circuitry 24 is illustrated as including a single processor 26, a single instance of transceiver circuitry 28, a single instance of front end circuitry 40, and a single set of antenna(s) 42 for the sake of clarity. In general, wireless circuitry 24 may include any number of processors 26, any number of instances of transceiver circuitry 28, any number of instances of front end circuitry 40, and any number of sets of antenna(s) 42. Each processor 26 may be coupled to one or more transceivers (e.g., instances of transceiver circuitry 28) over respective paths 34. Each transceiver 28 may include a transmitter circuit 30 configured to output uplink signals to antenna(s) 42, may include a receiver circuit 32 configured to receive downlink signals from antenna(s) 42, and may be coupled to one or more antennas 42 over respective radio-frequency transmission line paths 36. Each radio-frequency transmission line path 36 may have respective front end circuitry 40 disposed thereon. If desired, two or more instances of (different types of) front end circuitry 40 may be disposed on the same radio-frequency transmission line path 36. If desired, one or more of the radio-frequency transmission line paths 36 in wireless circuitry 24 may be implemented without any front end circuitry 40 disposed thereon.

Antenna(s) 42 may be formed using any desired antenna structures. For example, antenna(s) 42 may each be an antenna with an antenna resonating element that is formed from loop antenna structures, patch antenna structures, inverted-F antenna structures, slot antenna structures, planar inverted-F antenna structures, helical antenna structures, monopole antennas, dipole antennas, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

Each radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path that is coupled to the positive antenna feed terminal on antenna 42. Radio-frequency transmission line path 36 may have a ground transmission line signal path that is coupled to the ground antenna feed terminal on antenna 42. This example is merely illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency signals within device 10 (FIG. 1). These transmission lines may include coaxial cables, microstrip transmission lines, stripline transmission lines, edge-coupled microstrip transmission lines, edge-coupled stripline transmission lines, transmission lines formed from combinations of transmission lines of these types, etc. If desired, transmission lines in radio-frequency transmission line paths 36 may be integrated into rigid printed circuit boards and/or flexible printed circuit substrates.

In performing wireless signal transmission, processor(s) 26 may provide transmit signals (e.g., digital or baseband signals) to transceiver circuitry 28 over path 34. Transceiver circuitry 28 may further include circuitry for converting the transmit (baseband) signals received from processor 26 into corresponding radio-frequency signals. For example, transceiver circuitry 28 may include mixer circuitry for up-converting (or modulating) the transmit (baseband) signals to radio-frequencies prior to transmission over antenna 42. The example of FIG. 2 in which processor 26 communicates with transceiver circuitry 28 is merely illustrative. In general, transceiver circuitry 28 may communicate with a baseband processor, an application processor, general purpose processor, a microcontroller, a microprocessor, or one or more processors within circuitry 18 (e.g., implementing the functions of processor 26). Transceiver circuitry 28 may also include digital-to-analog converter (DAC) and/or analog-to-digital converter (ADC) circuitry for converting signals between digital and analog domains. Transceiver circuitry 28 may use transmitter (TX) 30 to transmit the radio-frequency signals over antenna(s) 42 via radio-frequency transmission line path 36 and front end circuitry 40. Antenna(s) 42 may transmit the radio-frequency signals to external wireless equipment by radiating the radio-frequency signals into free space.

In performing wireless reception, antenna(s) 42 may receive radio-frequency signals from the external wireless equipment. The received radio-frequency signals may be conveyed to transceiver circuitry 28 via radio-frequency transmission line path 36 and front end circuitry 40. Transceiver circuitry 28 may include circuitry such as receiver (RX) 32 for receiving signals from front end circuitry 40 and for converting the received radio-frequency signals into corresponding baseband signals. For example, transceiver circuitry 28 may include mixer circuitry for down-converting (or demodulating) the received radio-frequency signals to baseband frequencies prior to conveying the received signals to processor 26 (or control circuitry 18 implementing the function of processor 26) over path 34.

Radio-frequency front end circuitry 40 may operate on the radio-frequency signals conveyed (transmitted and/or received) over radio-frequency transmission line path 36. Front end circuitry 40 may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifier circuits and/or one or more low-noise amplifier circuits), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along (e.g., on) radio-frequency transmission line path 36, may be incorporated into a front end module, and/or may be incorporated into antenna 42 (e.g., to support antenna tuning, to support operation in desired frequency bands, etc.). At least some of these components may form antenna tuning components that are adjusted (e.g., using control circuitry 14) to adjust the frequency response and wireless performance of antenna 42 over time.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processor 26 and/or portions of transceiver circuitry 28 (e.g., a host processor on transceiver circuitry 28) may form a part of control circuitry 14. Control circuitry 14 (e.g., portions of control circuitry 14 formed on processor 26, portions of control circuitry 14 formed on transceiver circuitry 28, and/or portions of control circuitry 14 that are separate from wireless circuitry 24) may provide control signals (e.g., over one or more control paths in device 10) that control the operation of front end circuitry 40.

Transceiver circuitry 28 may be separate from front end circuitry 40. For example, transceiver circuitry 28 may be formed on another substrate such as the main logic board of device 10, a rigid printed circuit board, or flexible printed circuit different than the one on which front end circuitry 40 is provided.

Radio-frequency transceiver circuitry 28 (and other portions wireless circuitry 24 such as front end circuitry 40) may handle transmission and/or reception of radio-frequency signals in various radio-frequency communications bands. For example, radio-frequency transceiver circuitry 28 (and other portions wireless circuitry 24 such as front end circuitry 40) may handle radio-frequency signals in wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz), or other cellular communications bands between about 600 MHz and about 5000 MHz (e.g., 3G bands, 4G LTE bands, 5G New Radio Frequency Range 1 (FR1) bands below 10 GHz, 5G New Radio Frequency Range 2 (FR2) bands at millimeter and centimeter wavelengths between 20 and 60 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), an ultra-wideband (UWB) communications band supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled (e.g., covered) by radio-frequency transceiver circuitry 28 (and other portions wireless circuitry 24 such as front end circuitry 40) may sometimes be referred to herein as frequency bands or simply as “bands,” and may span corresponding ranges of frequencies.

Electronic device 10 (FIG. 1) may include multiple sub-systems for implementing and/or supporting different device functions. These sub-system can each include integrated circuit(s) and/or discrete electrical components operable to collectively perform the corresponding device function. As examples, electronic device 10 may include display sub-system(s) that each include a display (e.g., as described in connection with input-output devices 22 in FIG. 1) and other components that support the operation of the display, may include camera sub-system(s) that each include camera(s) (e.g., as described in connection with input-output devices 22) and other components that support the operation of the camera(s), may include other sensor sub-system(s) that each include one or more different type(s) of sensor(s) (e.g., as described in connection with input-output devices 22) and other components that support the operation of the sensors(s), may include wireless communications circuitry sub-system(s) that each include radio-frequency components (e.g., antennas 42, front end circuitry 40, transceiver circuitry 28, and/or other parts of wireless circuitry 24) for operating in one or more radio-frequency band(s), one or more protocols, and/or one or more wireless technologies, etc. (e.g., as described in connection with wireless circuitry 24 in FIG. 2), and/or may include other electronic device sub-systems (e.g., associated with any of the components of device 10 described in connection with FIGS. 1 and 2).

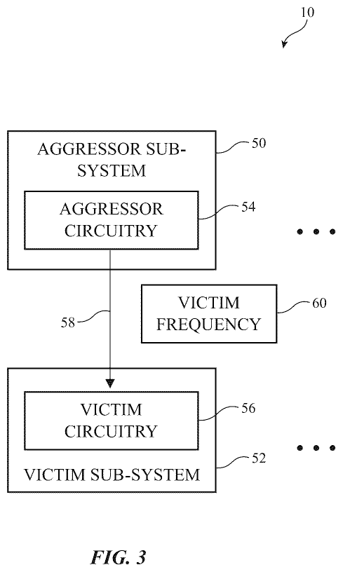

Operation of one sub-system can interfere with and adversely impact operation(s) of one or more other sub-systems. The interfering sub-system can sometimes be referred to as an aggressor sub-system, whereas the adversely impacted sub-system(s) can sometimes be referred to as victim sub-system(s). FIG. 3 is a diagram of two illustrative sub-systems of device 10. In the example of FIG. 3, a first sub-system 50 may be an aggressor subsystem, whereas a second sub-system 52 may be a victim sub-system. In particular, sub-system 50 may include circuitry such as aggressor circuitry 54 whose operation may cause the generation of a noise 58 at a frequency 60 (sometimes referred to as victim frequency 60 due to its overlap with an operating frequency (band) of victim sub-system(s) and circuitry therein, such as a frequency (band) handled by wireless circuitry 24). Some aggressor sub-systems may generate broadband noise of which noise 58 at frequency 60 is one noise component. Accordingly, such an aggressor sub-system may generate noise components at different victim frequencies, which can interfere with operations of multiple victim sub-systems.

Victim sub-system 50 may include circuitry such as victim circuitry 56 that operates based on signals at frequency 60 (e.g., having signal components at frequency 60). Accordingly, noise 58 at frequency 60 may be introduced into (e.g., coupled onto via direct electrical connections, via indirect electromagnetic coupling, via indirect radio-frequency signal radiation, etc.) and received by signal paths conveying operating signals of victim circuitry 56, thereby interfering with operation of victim circuitry 56 (e.g., by increasing signal-to-noise ratio, by increase signal jitter, and/or degrading other signal quality metrics of the operating signals used and/or processed by victim circuitry 56).

While two illustrative sub-systems serving as an aggressor and a victim are shown in the example of FIG. 3, this is merely illustrative. In general, multiple sub-systems (e.g., sub-systems in additional to sub-system 50) may serve as aggressors towards a single victim sub-system (e.g., sub-system 52) by producing noise at the same victim frequency, and/or multiple sub-systems (e.g., sub-systems in addition to sub-system 52) may be victimized by a single aggressor sub-system (e.g., sub-system 40) by producing noise at different victim frequencies (e.g., broadband noise) that interferes with the multiple sub-systems that operate at the different victim frequencies. A victim sub-system (e.g., containing multiple victim circuitry instances) may operate at multiple (victim) frequencies, each of which may be adversely impacted by noise at the victim frequencies produced by any number of aggressor sub-systems.

Aggressor sub-systems may each be a display sub-system, a camera sub-system, another type of sensor sub-system, a wireless circuitry sub-system, or any other electronic device sub-system. Victim sub-systems may each be a display sub-system, a camera sub-system, another type of sensor sub-system, a wireless circuitry sub-system, or any other electronic device sub-system. In some instances, the same sub-system may serve as both an aggressor and a victim (e.g., at the time, at different times, with respect to different sets of sub-system(s), with respect to the same sub-system, etc.).

Illustrative configurations in which an aggressor sub-system and a victim sub-system are each a different wireless circuitry sub-system are sometimes described herein as an example. Accordingly, aggressor circuitry in the aggressor sub-system may include first radio-frequency circuitry (e.g., first radio-frequency front end circuitry 40, first radio-frequency transceiver circuitry 28, and/or a first set of other radio-frequency components of wireless circuitry 24). Victim circuitry in the victim sub-system may include second radio-frequency circuitry (e.g., second radio-frequency front end circuitry 40, second radio-frequency transceiver circuitry 28, and/or a second set of other radio-frequency components of wireless circuitry 24).

This example is merely illustrative. If desired, the embodiments described herein may similarly be applicable to non-wireless-circuitry sub-systems as the aggressor and/or as the victim.

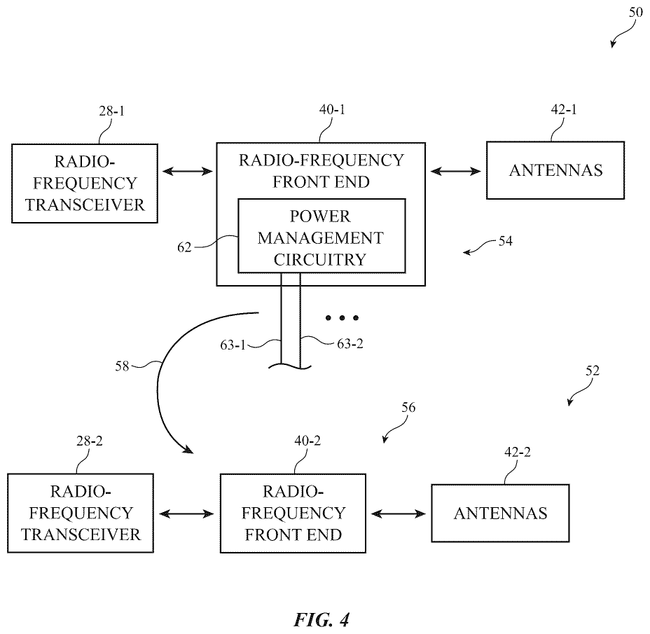

FIG. 4 is a diagram of illustrative radio-frequency aggressor circuitry (e.g., circuitry 54 in sub-system 50 of FIG. 3) and radio-frequency victim circuitry (e.g., circuitry 56 in sub-system 52 of FIG. 3). In the example of FIG. 4, aggressor sub-system 50 may include radio-frequency transceiver 28-1 (e.g., an instance of transceiver circuitry 28 in FIG. 2), radio-frequency front end 40-1 (e.g., an instance of front end circuitry 40 in FIG. 2), and antennas 42-1 (e.g., one or more of antennas 42 in FIG. 2). Victim sub-system 52 may include radio-frequency transceiver 28-2 (e.g., an instance of transceiver circuitry 28 in FIG. 2), radio-frequency front end 40-2 (e.g., an instance of front end circuitry 40 in FIG. 2), and antennas 42-2 (e.g., one or more of antennas 42 in FIG. 2). In one illustrative configuration, transceiver 28-1 may be a 5G NR FR2 transceiver, intermediate frequency processing stages may be coupled between transceiver 28-1 and radio-frequency front end 40-1, and antennas 42-1 may form a phased antenna array. If desired, other configurations of sub-system 50 may be used.

As shown in FIG. 4, front-end circuitry 40-1 may include (or generally have radio-frequency components that are coupled to) power management circuitry 62. Power management circuitry 62 may have terminals or ports coupled to a plurality of signal paths such as signal paths 63-1 and 63-2. As an example, signal path 63-1 may be a power supply path that provides a supply voltage for operating front end circuitry 40-1, and signal path 63-2 may be a communications signal path (e.g., for conveying a clock signal and/or data signals to and/or from front end circuitry 40-1). In particular, power management circuitry 62 may convert the received power supply voltage on path 63-1 to one or more additional voltage values for use by front end circuitry 40-1 (e.g., along with the received power supply voltage).

Signal(s) carried on signal paths 63-1 and/or 63-2 may be noisy and include broadband noise. As part of the broadband noise, noise (component) 58 at a victim frequency may be produced during operation of front end circuitry 40-1, thereby impacting victim radio-frequency circuitry operating at the victim frequency. Accordingly, power management circuitry 62 and/or front-end circuitry 40-1 may be considered as the aggressor circuitry or the aggressor radio-frequency circuitry.

In the example of FIG. 4, noise 58 may interfere with the operation of front end circuitry 40-2, which may be considered the victim (radio-frequency) circuitry. In particular, path 63-1 (or path 63-2) carrying noise 58 as part of the power supply signal conveyed thereon may be coupled (e.g., via shared supply lines providing the supply voltage to both front ends 40-1 and 40-2, via electromagnetic coupling, via radio-frequency radiation with path 63-1 and/or other components coupled thereto serving as a radiator, and/or via other direct or indirect means) to front end circuitry 40-2 (e.g., to radio-frequency components therein, to signal lines therein or coupled thereto, etc.). Accordingly, noise 58 at the victim frequency may be undesirably introduced to and received by front end circuitry 40-2.

While noise at a single victim frequency can be removed (e.g., filtered out) by coupling a filter to the aggressor or the victim, this approach is not scalable as the number of sub-systems in an electronic device increases (e.g., the number of aggressor-victim combinations increases), requiring more and more filters. Inter-coupling between such filters, especially when placed in close proximity given a compact electronic device form-factor, can also render them ineffective at their predetermined filtering (e.g., rejection) frequencies.

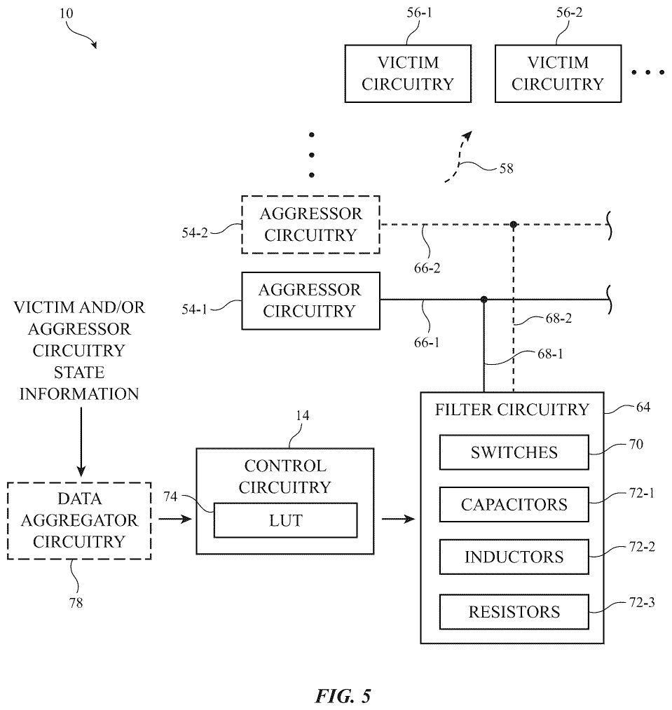

To overcome these limitations and/or impart other advantages, an electronic device such as device 10 may be configured to perform adaptive filtering for removing victim frequency noise from aggressor sub-systems (e.g., aggressor circuitry and signal paths therein) and/or from victim sub-systems (e.g., victim circuitry and signal paths therein) based on the operating states of aggressor and/or victim sub-systems. FIG. 5 is a diagram of illustrative aggressor circuitry (of a corresponding sub-system) coupled to tunable filter circuitry that is adaptively controlled.

As shown in FIG. 5, device 10 may include aggressor circuitry 54-1 (e.g., an instance of aggressor circuitry 54 in FIG. 3, radio-frequency circuitry 40-1 as described in connection with FIG. 4, etc.). Aggressor circuitry 54-1 may be coupled to one or more signal paths 66-1 (e.g., a power supply path such as path 63-1 in FIG. 4, a communications path such as path 63-2 in FIG. 4, and/or other types of signals paths on which signal containing victim frequency noise component(s) can be conveyed). Path 66-1 may be an internal path, a path between circuitry 54-1 and another portion of the same sub-system, or a path between circuitry 54-1 and external circuitry (e.g., outside of the same sub-system). Aggressor circuitry 54-1 may receive and/or transmit signals on signal paths 66-1 that contain noise component(s) (e.g., noise 58) at one or more victim frequencies, adversely affecting operation of victim circuitry 56-1, 56-2, etc., (e.g., multiple instances of victim circuitry 56 in FIG. 3, multiple instances of the radio-frequency circuitry as described in connection with FIG. 4, etc.).

Aggressor circuitry 54-1 and path 66-1 may be coupled to tunable filter circuitry 64 (sometimes referred to herein as a tunable filter network 64) via path 68-1. Tunable filter circuitry 64 may include switching circuitry such as one or more switches 70 (sometimes referred to herein as switching circuitry 70), and one or more filter components such as one or more capacitors 72-1, one or more inductors 72-2, and one or more resistors 72-3. In particular, tunable filter circuitry 64 may include one or more filters (e.g., one or more notch filters with the victim frequencies as the rejection frequencies or other frequency-rejection or band-rejection filters rejecting the victim frequencies, or other types of filters for removing victim frequency noise). Each of these filters may be formed from a combination of switch(es) 70, capacitor(s) 72-1, inductor(s) 72-2, and/or resistor(s) 72-3, with the capacitor(s) 72-1 having filter-specific capacitance(s), inductor(s) 72-2 having filter-specific inductance(s), and/or resistor(s) 72-3 having filter-specific resistance(s). As examples, the filters may include capacitive filter(s), inductive filter(s), LC (inductive-capacitive) filter(s) such as pi-type filter(s), L-type filter(s), T-type filter(s), etc., and/or other types of filter(s).

The filters of circuitry 64 may be used to reject one or more noise components at victim frequencies on path 66-1. If desired, additional instances of aggressor circuitry such as aggressor circuitry 54-2 (e.g., in the same sub-system as circuitry 54-1 or in a different sub-system than circuitry 54-1) may be coupled to the same tunable filter circuitry 64. In general, any number of instances of aggressor circuitry 54 may be coupled to and share the same filter circuitry 64. In the example of FIG. 5, aggressor circuitry 54-2 may also be coupled to filter circuitry 64 via paths 66-2 and 68-2. In this example, the filters of filter circuitry 64 may be used to reject one or more noise components at victim frequencies on path 66-2.

Control circuitry such as a portion of control circuitry 14 in FIG. 1 (e.g., one or more processors 18) may be used to control the (filter) state of tunable filter circuitry 64. While configurations in which control circuitry 14 is used to control the filter state of filter circuitry 64 are sometimes described herein as an example, this example is merely illustrative. If desired, processor(s) 26 and/or other portions of wireless circuitry 24 in FIG. 2 may perform these operations (e.g., shown and described to be performed by control circuitry 14) instead of or in addition to control circuitry 14. In instances in which the aggressor circuitry forms part of wireless circuitry 24 in FIG. 2 (e.g., is formed from radio-frequency circuitry as described in connection with FIG. 4), the components of device 10 (e.g., aggressor circuitry 54-1, 54-2, etc., filter circuitry 64, the one or more processors controlling filter state, etc.) shown in FIG. 5 may be considered portions of wireless circuitry 24.

In particular, tunable filter circuitry 64 may have and be configurable to exhibit a plurality of filter states, each corresponding to a different combination of filter(s) therein being connected to one or more of the aggressor circuitry paths 66-1, 66-2, etc.

Control circuitry 14 may determine the filter state and place filter circuitry 64 in the determined filter state based on victim circuitry state information and/or aggressor circuitry state information. In some illustrative configurations sometimes described herein as an example, victim circuity state information may include indication(s) of active victim circuitry instances (e.g., currently operating victim circuitry 56 in device 10 susceptible to noise 58 at corresponding victim frequencies), may include indication(s) of one or more victim frequencies (or frequency bands) at which active victim circuitry instances in device 10 are operating, etc. Aggressor circuity state information may include indication(s) of active aggressor circuitry instances (e.g., currently operating aggressor circuitry 54 in device 10 whose operations cause noise 58 at corresponding victim frequencies to be produced), may include indication(s) of one or more victim frequencies (or frequency bands) produced by active aggressor circuitry instances, etc.

Control circuitry 14 may store (e.g., in storage circuitry 16) a lookup table (LUT) 74. Lookup table 74 may store a set of entries that each map victim circuitry state information (e.g., frequency bands in which victim circuitry instances are actively operating) to filter states of tunable filter circuitry 64 that reject noise at victim frequencies in the corresponding victim circuitry frequency bands. If desired, lookup table 74 may also incorporate aggressor circuitry state information in the mapping (e.g., provide a mapping of a combination of victim circuitry state information and aggressor circuitry state information to filter states, provide a mapping of frequency bands in which victim circuitry instances are actively operating and at which noise is produced by aggressor circuitry instances to the filter states of filter circuitry 64, etc.).

Accordingly, when control circuitry 14 receives victim and/or aggressor circuitry state information indicative of the current operating scenario, control circuitry 14 may perform a lookup operation using the received state information to determine a corresponding filter state that performs noise rejection for the current operating scenario. Based on the determined filter state, control circuitry 14 may provide control and/or other signal(s) to filter circuitry 64 to place filter circuitry 64 in the determined filter state. The provided (control) signal(s) may control the states of corresponding switches 70, may control the states (e.g., capacitance, inductance, and resistance states) of capacitors 72-1, inductor 72-2, and resistors 72-3, if tunable, and/or may control other components or setting of filter circuitry 64.

If desired, instead of or in addition to using lookup table 74 to determine filter states, control circuitry 14 may determine a desired filter state of circuitry 64 based on victim circuitry operating signals. In particular, victim circuitry state information received by control circuitry 14 may include one or more signal quality metrics of a victim circuitry operating signal susceptible to the victim frequency noise component 58. These signal quality metrics may include a signal-to-noise ratio, a signal jitter, and/or other signal quality metrics. As examples, responsive to a criterion based on the signal quality metric being met (e.g., a signal-to-noise ratio being below a fixed or variable threshold value), control circuitry 14 may control filter circuitry 64 to exhibit a filter state to remove the victim frequency noise component(s) 58 to improve the signal quality metric, may (fine-)tune the rejection characteristics of the actively connected filters to improve the signal quality metric, etc. This type of control based on the signal quality metric may be a continuous process, may occur periodically, may occur after filter circuitry 64 has been placed in an initial (e.g., coarse) filter state with one or more actively connected filters based on a lookup operation using lookup table 74, etc.

In some illustrative configurations described as an example, filter circuitry 64 may exhibit a first set of coarse filter states (e.g., indicative of which filter(s) are to be connected for noise rejection and/or to be determined by a lookup operation using lookup table 74) and may exhibit a second set of fine-tuning filter states (e.g., indicative of tuning for the connected filter(s) such as by adjusting capacitance and/or inductance values of the connected filter(s), and/or to be determined based on the signal-metric-based control scheme).

If desired, data aggregator circuitry 78 may be coupled to control circuitry 14 to aggregate state information of victim circuitry instances and/or aggressor circuitry instances. In such a manner, data aggressor circuitry 78 may be coupled to each of the sub-systems and/or other sources of victim and/or aggressor circuitry state information and serve as interfacing circuitry for control circuitry 14. If desired, data aggregator circuitry 78 may process the received state information and output the state information in a desired format to control circuitry 14. If desired, the functions of data aggressor circuitry 78 as described above may be implemented by a portion of control circuitry 14.

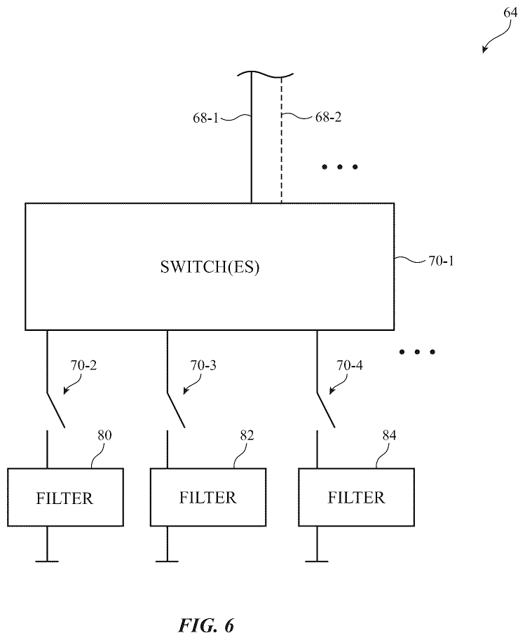

FIG. 6 is a diagram of an illustrative tunable filter network 64 (tunable filter circuitry 64). As shown FIG. 6, tunable filter network 64 may include three illustrative filters 80, 82, and 84, each formed from a combination of switch(es) 70, capacitor(s) 72-1, inductor(s) 72-2, and/or resistor(s) 72-3, with the capacitor(s) 72-1 having filter-specific capacitance(s), inductor(s) 72-2 having filter-specific inductance(s), and/or resistor(s) 72-3 having filter-specific resistance(s). As examples, filters 80, 82, and 84 may each include capacitive filter(s), inductive filter(s), LC (inductive-capacitive) filter(s) such as pi-type filter(s), L-type filter(s), T-type filter(s), etc., and/or other types of filter(s). While filters 80, 82, and 84 are shown as separate and distinct elements, this is merely illustrative. If desired, one or more components (e.g., switch(es) 70, capacitor(s), inductor(s), and/or resistor(s)) within a given filter may be shared by one or more other filters.

Switching circuitry such as switch(es) 70-1, 70-2, 70-3, and 70-4 (instances of switches 70 in FIG. 5) may be coupled between the filters and corresponding paths 68-1, 68-2, etc., each coupled to a corresponding aggressor circuitry path 66 (FIG. 5). In some illustrative configurations, switching circuitry 70-1 may include a multi-pole multi-throw switch for selectively connecting (e.g., based on control signals from control circuitry 14) any number of paths 68 (e.g., paths 68-1, 68-2, etc.) to any of the filtering paths (e.g., containing a switch and a corresponding filter in the example of FIG. 6). Switches 70-2, 70-3, 70-4, etc., may each be a single-pole single-throw switch coupled along their respective filtering paths.

In the example of FIG. 6, filter 80 may be used to reject (e.g., block) a first victim frequency (e.g., a noise component at the first victim frequency caused by aggressor operation), filter 82 may be used to reject (e.g., block) a second victim frequency (e.g., a noise component at the second victim frequency caused by aggressor operation), and filter 84 may be used to reject (e.g., block) a third victim frequency (e.g., a noise component at the third victim frequency caused by aggressor operation). As an example, aggressor circuitry 54-1 (FIG. 5) may be configured to generate all three noise components at all three victim frequencies on path 66-1 coupled to path 68-1. Accordingly, depending on which, if any, victim circuitry instances affected by these three noise components are currently operating, control circuitry 14 may place filter network 64 in a corresponding filter state (e.g., may control switches 70-1, 70-2, 70-3, and 70-4 to connect one or more of filters 80, 82, and/or 84 to path 68-1 and path 66-1).

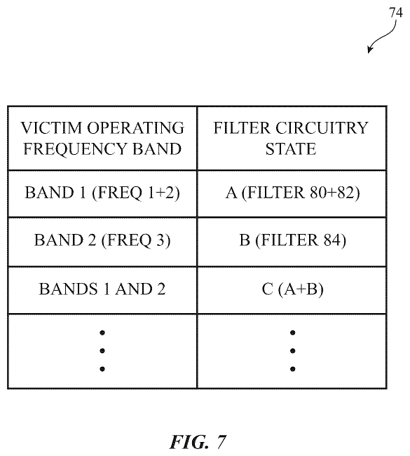

FIG. 7 shows an illustrative lookup table (e.g., lookup table 74 in FIG. 5) that may be used in conjunction with the example described above in connection with FIG. 6. In particular, lookup table 74 may map frequency bands of currently operating victim circuitry instances to filter circuitry states (e.g., of filter network 64 in FIG. 6). As shown in the example of claim 7, when the victim circuitry instance(s) are only operating in a first victim frequency band containing first and second victim frequencies, a first filter state A (in which filters 80 and 82 are connected to path 66-1 to reject the first and second victim frequencies) may be used. In other words, responsive to control circuitry 14 receiving an indication of active victim circuitry operating in the first victim frequency band (e.g., as victim circuitry state information), control circuitry 14 may place filter network 64 in filter state A by controlling switching circuitry 70 to connect filters 80 and 82 to path 68-1 and path 66-1 (and to any other aggressor circuitry paths on which noise in the first and second victim frequencies are present).

When the victim circuitry instance(s) are only operating in a second victim frequency band containing a third victim frequency, a second filter state B (in which filter 84 is connected to path 66-1 to reject the third victim frequency) may be used. In other words, responsive to control circuitry 14 receiving an indication of active victim circuitry operating in the second victim frequency band (e.g., as victim circuitry state information), control circuitry 14 may place filter network 64 in filter state B by controlling switching circuitry 70 to connect filter 84 to path 68-1 and path 66-1 (and to any other aggressor circuitry paths on which noise in the third victim frequency is present).

When the victim circuitry instance(s) are operating in both the first and second victim frequency bands containing the first, second, and third victim frequencies, a third filter state C (in which filters 80, 82, and 84 are connected to path 66-1 to reject the first, second, and third victim frequencies) may be used. In other words, responsive to control circuitry 14 receiving an indication of active victim circuitry operating in the first and second victim frequency bands (e.g., victim circuitry state information), control circuitry 14 may place filter network 64 in filter state C by controlling switching circuitry 70 to connect filters 80, 82, and 84 to path 68-1 and path 66-1 (and to any other aggressor circuitry paths on which noise in the first, second, and third victim frequency is present).

Referring back to FIGS. 5 and 6, any suitable number of paths 68 may (selectively) connect any suitable number of filters such as filters 80, 82, and 84 in filter network 64 to corresponding aggressor circuitry paths (e.g., paths 66-1, 66-2, etc., in FIG. 5). Different aggressor circuitry instances (e.g., aggressor circuitry 54-1 and 54-2 in FIG. 5) that produce noise components at one or more same victim frequencies on corresponding paths (e.g., paths 66-1 and 66-1) may share use of the same filter for noise rejection at the same victim frequencies when the corresponding filter state(s) are used.

While configurations in which tunable filter circuitry is coupled to aggressor circuitry paths (e.g., to reject victim frequency noise produced on the aggressor circuitry paths that convey signals for the aggressor circuitry) are described in connection with FIGS. 5-8, these configurations are merely illustrative. If desired, tunable filter circuitry may be coupled to victim circuitry paths (e.g., to reject victim frequency noise received by the victim circuitry paths that convey signals for the victim circuitry). The tunable filter circuitry coupled to victim circuitry paths may be provided in addition to or instead of providing tunable filter circuitry coupled to aggressor circuitry paths.

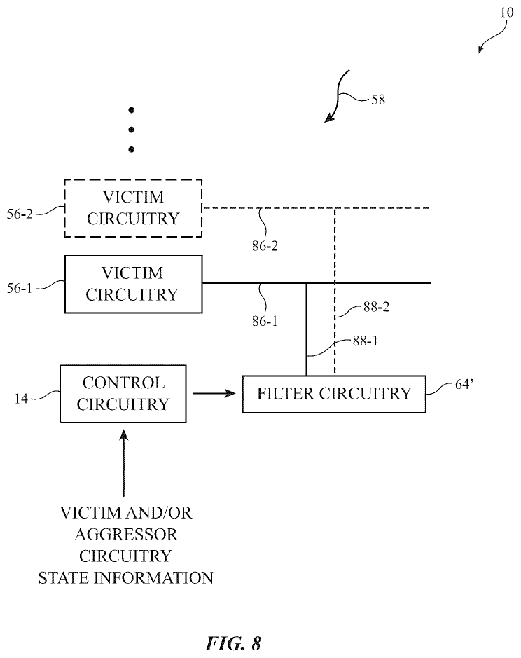

FIG. 8 is a diagram of illustrative victim circuitry (of a corresponding sub-system) coupled to tunable filter circuitry that is adaptively controlled. As shown in FIG. 8, one or more instances of victim circuitry 56-1, 56-2, etc., (e.g., multiple instances of victim circuitry 56 in FIG. 3, multiple instances of the victim radio-frequency circuitry as described in connection with FIG. 4, etc.) may each include and/or be to a corresponding signal path 86 (e.g., paths 86-1, 86-2, etc.). An instance of victim circuitry 56 may transmit and/or receive signals at one or more victim frequencies (e.g., having signal components at the one or more victim frequencies) on the corresponding victim circuitry path 86. Noise such as victim frequency noise 58 from aggressor circuitry such as radio-frequency circuitry 40-1 in FIG. 4 and/or other instances of aggressor circuitry 56 in FIGS. 3 and 5 (e.g., broadband noise produced based on the operation of one or more instances of aggressor circuitry containing noise components at the one or more victim frequencies) may be received by and coupled onto paths 86, thereby interfering with victim circuitry operations.

To adaptively reject victim frequency noise 58, the one or more instances of victim circuitry 56-1, 56-2, etc., and the one or more victim circuitry paths 86-1, 86-2, etc., be coupled to tunable filter circuitry 64′. Tunable filter circuitry 64′ may be another instance of tunable filter circuitry 64 in FIGS. 5 and 6. If desired, tunable filter circuitry 64′ may have the same filters and switching circuitry as tunable filter circuitry 64. If desired, tunable filter circuitry 64′ may have a different number and/or different type(s) of filters and switching circuitry that are coupled or otherwise configured in a different manner than tunable filter circuitry 64.

As one example, filter circuitry 64′ may include at least filters for rejecting noise at each victim frequency at which the coupled victim circuitry instances operate and/or at which noise is produced based on aggressor circuitry operation in device 10. In some instances, because tunable filter circuitry 64 is configured to reject broadband noise on aggressor circuitry paths (e.g., paths 66-1, 66-2, etc.) that include components at all victim frequencies, tunable filter circuitry 64 (FIGS. 5 and 6) may include a greater number of filters than tunable filter circuitry 64′ (FIG. 8) which may perform noise rejection for only a subset of victim circuitry in device 10 (e.g., operating at a subset of victim frequencies to be rejected by filter circuitry 64′).

Tunable filter circuitry 64′ may exhibit multiple filter states in which different combinations of one or more filters are connected to paths 86 (e.g., 86-1, 86-2, etc.) to perform noise rejection. Control circuitry such as a portion of control circuitry 14 (e.g., one or more processors 18 in FIG. 1) and/or processor(s) 26 in FIG. 2 may be configured to place tunable filter circuitry 64′ in different filter states based on victim and/or aggressor circuitry state information, e.g., in an analogous manner as described in connection with tunable filter circuitry 64 in FIGS. 5-7. In particular, control circuitry 14 similarly stored a lookup table (e.g., in storage circuitry 16) mapping the state information to filter states and use the lookup table to determine the appropriate filter state based on the received state information, and/or control circuitry 14 may obtain victim circuitry signal quality metrics (e.g., signal-to-noise ratio, signal jitter, etc.) as part of the victim circuitry state information and may determine the appropriate filter state (e.g., determine a tuning of the current filter state, determine a fine-tuned filter state, etc.) based on the received victim circuitry signal quality metric. Control circuitry 58 may subsequently provide control signal(s) and/or other signals(s) to tunable filter circuitry 64′ to place tunable filter circuitry 64′ in the determined filter state.

In instances in which the victim circuitry forms part of wireless circuitry 24 in FIG. 2 (e.g., is formed from radio-frequency circuitry as described in connection with FIG. 4), the components of device 10 (e.g., victim circuitry 56-1, 56-2, etc., filter circuitry 64', the one or more processors controlling filter state, etc.) shown in FIG. 8 may be considered portions of wireless circuitry 24.

In general, any suitable number of instance(s) of tunable filter circuitry may each be coupled to any combination of instance(s) of aggressor circuitry and/or any combination of instance(s) of victim circuitry. The tunable filter circuitry may be provided as a part of the integrated circuit of the aggressor or victim circuitry and/or within corresponding aggressor or victim sub-system(s), or may be provided as a separate discrete component coupled to the integrated circuit implementing the aggressor or victim circuitry and/or outside the corresponding aggressor or victim sub-system(s).

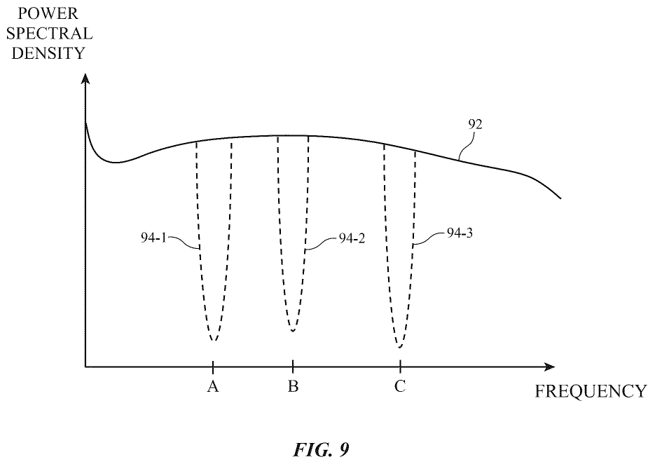

FIG. 9 is an illustrative graph showing the effects of adaptive filtering on power spectral density of signals containing broadband noise (e.g., signals containing broadband noise generated at aggressor circuitry). In the example of FIG. 9, signals without filtering at aggressor circuitry (e.g., aggressor circuitry 54-1, 54-2, etc., in FIG. 5) may exhibit power spectral density across frequencies as shown by curve 92. These signals may contain noise components at first, second, and third (radio) frequencies (e.g., frequencies A, B, and C in FIG. 9), among other frequency components. These three frequencies may coincide with the operating frequencies (or frequency bands) of other components (e.g., victim circuitry) in the same device (e.g., device 10) and may therefore be first, second, and third victim frequencies.

Adaptive filter circuitry (e.g., filter circuitry 64) may be provided (e.g., in the manner described in connection with FIGS. 5-7) to filter victim frequency noise components from the frequency components indicated by curve 92 by placing the filter circuitry in different states. In the example of FIG. 9, when the filter circuitry is placed in a first filter state, the power spectral density of the signals may be modified to remove the (noise) component at the first victim frequency A (i.e., curve 92 may be modified to instead include curve portion 94-1 at (e.g., near) the first victim frequency A). When the filter circuitry is placed in a second filter state, the power spectral density of the signals may be modified to remove the (noise) component at the second victim frequency B (i.e., curve 92 may be modified to instead include curve portion 94-2 at (e.g., near) the second victim frequency B). When the filter circuitry is placed in a third filter state, the power spectral density of the signals may be modified to remove the (noise) component at the third victim frequency C (i.e., curve 92 may be modified to instead include curve portion 94-3 at (e.g., near) the third victim frequency C).

Depending on the different instances of victim circuitry (and their operating frequencies and/or frequency bands) in use in the same device, the filter circuitry may be placed one or more of these filter states. In particular, when a first instance of victim circuitry operating at frequency C is in use, the filter circuitry may be placed in the third filter state (i.e., curve 92 may exhibit filtering characteristics of curve portion 94-3). When a second instance of victim circuitry operating at frequencies A and B is in use (e.g., without the first instance of victim circuitry being in use), the filter circuitry may be placed in a composite filter state that includes the first and second filter states (i.e., curve 92 may exhibit filtering characteristics of curve portions 94-1 and 94-2). When both the first and second instances of victim circuitry are both in use (e.g., collectively operating at frequencies A, B, and C), the filter circuitry may be placed in another composite filter state that includes the first, second, and third filter states (i.e., curve 92 may exhibit filtering characteristics of curve portions 94-1, 94-2, and 94-3).

These examples and curves described in connection with FIG. 9 are merely illustrative. If desired, signals by aggressor circuitry may exhibit other noise characteristics (e.g., include noise components that are more narrowband), may exhibit other signal characteristics when filtered by different filter states, etc.

The methods and operations described above in connection with FIGS. 1-9 may be performed by the components of device 10 using software, firmware, and/or hardware (e.g., dedicated circuitry or hardware). Software code for performing these operations may be stored on non-transitory computer readable storage media (e.g., tangible computer-readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. Wireless communications circuitry comprising:
radio-frequency circuitry coupled to a signal path configured to convey a signal containing a victim frequency noise component that impacts victim circuitry operation;
tunable filter circuitry coupled to the signal path and having a plurality of filter states; and
control circuitry configured to receive victim circuitry state information and place the tunable filter circuitry in a given filter state of the plurality of filter states to remove the victim frequency noise component from the signal based on the received victim circuitry state information.

2. The wireless communications circuitry of claim 1, wherein the tunable filter circuitry comprises a plurality of filters and switching circuitry between the plurality of filters and the signal path and wherein the control circuitry is configured to place the tunable filter circuitry in the given filter state by controlling the switching circuitry to connect a given filter of the plurality of filters to the signal path.

3. The wireless communications circuitry of claim 2, wherein the plurality of filters each comprise at least one of a capacitor, an inductor, or a resistor.

4. The wireless communications circuitry of claim 1, wherein the control circuitry is configured to store a lookup table mapping the victim circuitry state information to the given filter state and wherein the control circuitry is configured to place the tunable filter circuitry in the given filter state by identifying the given filter state based on a lookup operation using the lookup table.

5. The wireless communications circuitry of claim 1, wherein the victim circuitry state information comprises a signal quality metric for a victim frequency and wherein the control circuitry is configured to place the tunable filter circuitry in the given filter state based on the signal quality metric.

6. The wireless communications circuitry of claim 5, wherein the signal quality metric comprises a signal-to-noise ratio or a signal jitter.

7. The wireless communications circuitry of claim 1, wherein the radio-frequency circuitry serves as aggressor circuitry that causes the victim frequency noise component during operation.

8. The wireless communications circuitry of claim 7, further comprising:
additional radio-frequency circuitry coupled to an additional signal path configured to convey an additional signal containing an additional victim frequency noise component that impacts the victim circuitry operation, wherein the tunable filter circuitry is coupled to the additional signal path.

9. The wireless communications circuitry of claim 7, wherein the radio-frequency circuitry comprises radio-frequency front end circuitry, the radio-frequency front end circuitry serving as the aggressor circuitry.

10. The wireless communications circuitry of claim 7, wherein the signal path is a power supply path that provides a supply voltage to the radio-frequency circuitry.

11. The wireless communications circuitry of claim 1, wherein the radio-frequency circuitry serves as victim circuitry impacted by the victim frequency noise component during the victim circuitry operation.

12. The wireless communications circuitry of claim 11, further comprising:
additional radio-frequency circuitry coupled to an additional signal path configured to convey an additional signal containing an additional victim frequency noise component that impacts additional victim circuitry operation, wherein the tunable filter circuitry is coupled to the additional signal path.

13. An electronic device comprising
an aggressor sub-system having first circuitry that operates with a signal containing a noise component at a victim frequency;
a victim sub-system having second circuitry that operates at the victim frequency;
a tunable filter network coupled to the first circuitry and having a plurality of filter states; and
control circuitry configured to receive an indication of one or more victim sub-systems, including the victim sub-system, being active and place the tunable filter network in a given filter state of the plurality of filter states to remove the noise component from the signal based on the indication of the one or more active victim sub-systems.

14. The electronic device of claim 13 further comprising:
an additional aggressor sub-system having third circuitry that operates with an additional signal containing an additional noise component at the victim frequency, wherein the tunable filter network is coupled to the additional aggressor sub-system.

15. The electronic device of claim 14, wherein the tunable filter network comprises one or more filters and switching circuitry between the one or more filters and the first circuitry and between the one or more filters and the third circuitry, wherein the control circuitry is configured to place the tunable filter network in the given filter state by controlling the switching circuitry to connect at least some of the one or more filters to the first circuitry to remove the noise component from the signal and by controlling the switching circuitry to connect at least some of the one or more filters to the third circuitry to remove the additional noise component from the additional signal.

16. The electronic device of claim 13, wherein the aggressor sub-system comprises a camera, a display, a sensor, or wireless communications circuitry.

17. The electronic device of claim 13, wherein the victim sub-system comprises a camera, a display, a sensor, or wireless communications circuitry.

18. Circuitry comprising:
storage circuitry; and
one or more processors coupled to the storage circuitry and configured to:
receive first state information of one or more victim sub-systems and second state information of one or more aggressor sub-systems, the one or more aggressor sub-systems producing a signal having one or more victim frequencies that interferes with operation of the one or more victim sub-systems;
determine a filter state of tunable filter circuitry coupled to the one or more aggressor sub-systems based on the first and second state information; and
provide one or more control signals to the tunable filter circuitry that place the tunable filter circuitry in the determined filter state.

19. The circuitry of claim 18, wherein the second state information comprises an indication of one or more active aggressor sub-systems, wherein the first state information comprises one or more operating frequency bands of one or more active victim sub-systems, and wherein the filter state of the tunable filter circuitry is determined based on the one or more operating frequency bands and the one or more active aggressor sub-systems.

20. The circuitry of claim 18, wherein the storage circuitry is configured to store a lookup table and wherein the one or more processors are configured to determine the filter state by performing a lookup operation based on the first and second state information to identify the filter state from the lookup table.
